(19) United States
(12) Patent Application Publication
(10) Pub. No.: US 2021/0124876 A1
(43) Pub. Date: Apr. 29, 2021

(54) Evaluating the Factual Consistency of Abstractive Text Summarization

(71) Applicant: salesforce.com, inc., San Francisco, CA (US)

(72) Inventors: Wojciech Kryscinski, San Francisco, CA (US); Bryan McCann, Palo Alto, CA (US)

(21) Appl. No.: 16/750,598

(22) Filed: Jan. 23, 2020

Related U.S. Application Data
(60) Provisional application No. 62/926,670, filed on Oct. 28, 2019.

(51) Int. Cl. G06F 40/30; G06F 40/268; G06F 16/34; G06K 9/62

(52) U.S. Cl. CPC G06F 40/30; G06K 9/6259; G06F 16/345; G06F 40/268

(57) ABSTRACT

A weakly-supervised, model-based approach is provided for verifying or checking factual consistency and identifying conflicts between source documents and a generated summary. In some embodiments, an artificially generated training dataset is created by applying rule-based transformations to sentences sampled from one or more unannotated source documents of a dataset. Each of the resulting transformed sentences can be either semantically variant or invariant from the respective original sampled sentence, and labeled accordingly. In some embodiments, the generated training dataset is used to train a factual consistency checking model. The factual consistency checking model can classify whether a corresponding text summary is factually consistent with a source text document, and if so, may identify a span in the source text document that supports the corresponding text summary.

### RELATED APPLICATIONS

This application claims priority to U.S. Provisional Patent Application No. 62/926,670, filed Oct. 28, 2019, which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to neural networks and learning models, and in particular, evaluating the factual consistency of abstractive text summarization.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Abstractive text summarization attempts to shorten (condense and rephrase) long textual documents into a human readable form that contains the most important facts from the original document. High-quality abstractive summarization requires that summaries remain factually consistent with source documents, but standard metrics for assessing summarization quality do not account for factual consistency.

### BRIEF DESCRIPTION OF THE DRAWINGS

FIG. 1 is a simplified diagram of a computing device according to some embodiments.

FIG. 2 is a simplified diagram of a method or process for generating an artificial, weakly-supervised data set for training a factual consistency checking model according to some embodiments.

FIG. 3 illustrates a table with examples of original sentences and their transformed forms, according to some embodiments.

FIG. 4 illustrates a method to generate training data for a factual consistency checking model, according to some embodiments.

FIG. 5 is a simplified diagram of a method, according to some embodiments, for checking factual consistency.

FIG. 6 illustrates a table with an example of a test pair of source document and sentence claim with spans identified by the factual consistency checking models of the present disclosure, according to some embodiments.

FIG. 7 illustrates a table with examples of factually incorrect claims that may be output by summarization models.

FIGS. 8A and 8B illustrates example results of factual consistency checking models of the present disclosure compared to other approaches, according to some embodiments.

FIG. 9 illustrates example results of evaluation of the spans generated by factual consistency checking models of the present disclosure, according to some embodiments.

In the figures, elements having the same designations have the same or similar functions.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### Overview

Artificial intelligence, implemented with neural networks and learning models, has demonstrated great promise as a technique for automatically analyzing real-world information with human-like accuracy. In general, such neural network and learning models receive input information and make predictions based on the input information.

One application for artificial intelligence is natural language processing (NLP), including text summarization. The goal of text summarization models is to transduce long documents into a shorter, human readable form that retains the most important aspects of the source document. Common approaches to summarization are extractive, abstractive, and hybrid. In extractive summarization, the model directly copies the salient parts of the source document into the summary. In abstractive summarization, the important parts of a source document are paraphrased to form novel sentences. Hybrid summarization combines the two approaches by employing specialized extractive and abstractive components. High-quality abstractive summarization requires that summaries remain factually consistent with source documents, but standard metrics for assessing summarization quality do not account for factual consistency.

Despite significant efforts, there are still challenges or problems limiting progress in text summarization models. One such problem is that of verifying factual consistency between source documents and generated summaries: a factually consistent summary should contain only statements that are entailed by the source document. However, studies have shown that a substantial number of summaries generated by abstractive models contain factual inconsistencies. Such high levels of factual inconsistency render automatically generated summaries virtually useless in practice.

The problem of factual consistency for text summarization models is closely related to natural language inference (NLI) and fact checking. Previously developed NLI datasets focus on classifying logical entailment between short, single sentence pairs, but verifying factual consistency can require incorporating the entire context of the source document. Fact checking focuses on verifying facts against the whole of available knowledge, whereas factual consistency checking focuses on adherence of facts to information provided by a source document without guarantee that the information is true.

According to some embodiments, the present disclosure provides a weakly-supervised, model-based approach for verifying or checking factual consistency and identifying conflicts between source documents and a generated summary. In some embodiments, an artificially generated training dataset is created by applying rule-based transformations to sentences sampled from one or more unannotated source documents of a dataset. These rule-based transformations can include a paraphrase transformation, entity and number swapping transformation, pronoun swapping data augmentation, sentence negation transformation, and injecting noise. Each of the resulting transformed sentences can be either semantically variant or invariant from the respective original sampled sentence, and labeled accordingly.

In some embodiments, dataset examples are created by first sampling single sentences, which may be referred to as “claims,” from the source documents. The claims then pass through a set of textual transformations that output novel sentences with both positive and negative labels.

The unannotated source documents and the labeled, transformed sentences can be provided to a neural network language model for training on checking or verifying factual consistency. It is demonstrated that training with this weak supervision substantially improves over using the strong supervision provided by previously developed datasets for NLI and fact-checking. Apart from the artificially generated training set, separate, manually annotated, development and test sets can be created in some embodiments.

In some embodiments, the factual consistency model is then trained separately or jointly on the generated training sets for one or more tasks relating to verifying the factual consistency of abstractive text summaries generated by a neural model for various source documents. In some embodiments, these tasks include: 1) identifying whether sentences remain factually consistent after transformation, 2) extracting a span in the source documents to support the consistency prediction, 3) extracting a span in the summary sentence that is inconsistent if one exists.

In some embodiments, the systems and methods of the present disclosure add specialized modules to the factual consistency model that explain which portions of both the source document and generated text summary are pertinent to the model's decision. It is demonstrated that the explanatory modules that augment the factual consistency model provide useful assistance to humans as they verify the factual consistency between a source document and generated summaries.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

### Computing Device

According to some embodiments, the systems of the present disclosure—including the various networks, models, and modules—can be implemented in one or more computing devices.

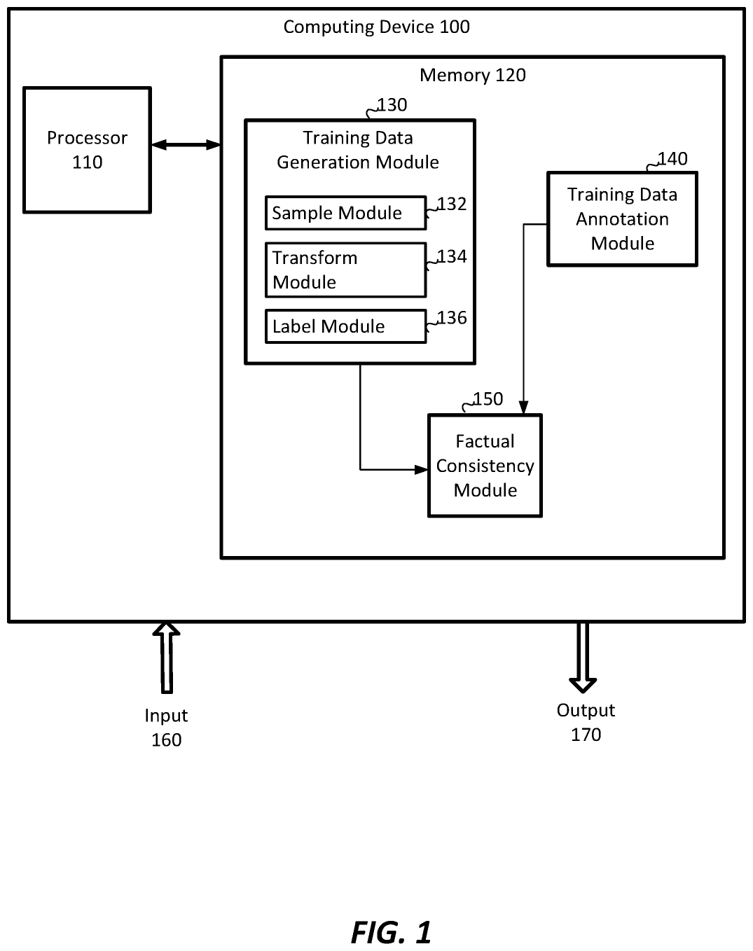

FIG. 1 is a simplified diagram of a computing device 100 according to some embodiments. As shown in FIG. 1, computing device 100 includes a processor 110 coupled to memory 120. Operation of computing device 100 is controlled by processor 110. And although computing device 100 is shown with only one processor 110, it is understood that processor 110 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 100. Computing device 100 may be implemented as a stand-alone subsystem, as a board added to a computing device, and/or as a virtual machine.

Memory 120 may be used to store software executed by computing device 100 and/or one or more data structures used during operation of computing device 100. Memory 120 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 110 and/or memory 120 may be arranged in any suitable physical arrangement. In some embodiments, processor 110 and/or memory 120 may be implemented on a same board, in a same package (e.g., system-in-package), on a same chip (e.g., system-on-chip), and/or the like. In some embodiments, processor 110 and/or memory 120 may include distributed, virtualized, and/or containerized computing resources. Consistent with such embodiments, processor 110 and/or memory 120 may be located in one or more data centers and/or cloud computing facilities. In some examples, memory 120 may include non-transitory, tangible, machine readable media that includes executable code that when run by one or more processors (e.g., processor 110) may cause the one or more processors to perform the methods described in further detail herein.

According to some embodiments, computing device 100 implements a weakly-supervised, model-based framework or approach for verifying factual consistency and identifying conflicts between source documents and a generated summary. In some embodiments, a document-sentence approach is implemented for factual consistency checking, where each sentence of the summary is verified against the entire body of the source document.

In some embodiments, as shown, memory 120 of computing device 100 includes a training data generation module 130, a data annotation module 140, and a factual consistency module 150 that may be used, either separately or in combination, to implement and/or emulate the systems and models, and/or to implement any of the methods described further herein.

In some examples, training data generation module 130 may be used to develop, derive, or generate an artificial training dataset by applying one or more rule-based transformations to the one or more sentences sampled or extracted from one or more unannotated source documents of a dataset to generate respective novel claim sentences. Each of the resulting claim sentences can be either semantically variant or invariant from the respective original sampled sentence, and training data generation module 130 labels them accordingly, for example, as “correct” if semantically invariant from the sampled sentence, or as “incorrect” if semantically variant from the sampled sentence. In some examples, as shown, training data generation module 130 includes a sample module 132, transform module 134, and label module 136.

Data annotation module 140 may be used to develop, derive, or generate an annotated test set of sentences or summaries.

The factual consistency module 150 can be trained—using the artificially generated training data set output from the training data generation module 130 and the annotated test set output from the data annotation module 140—for one or more tasks related to factual consistency verification. In some embodiments, these tasks include: 1) identifying whether sentences remain factually consistent after transformation, 2) extracting a span in the source documents to support the consistency prediction, 3) extracting a span in the summary sentence that is inconsistent if one exists.

In some examples, each of training data generation module 130, data annotation module 140, and factual consistency module 150 may be implemented using hardware, software, and/or a combination of hardware and software. In some embodiments, factual consistency module 150 can be implemented as a neural network model. In some embodiments, a Bidirectional Encoder Representations from Transformers (BERT) architecture (as described in further detail in Devlin et al., “BERT: pre-training of deep bidirectional transformers for language understanding,” CoRR, abs/1810.04805, 2018, the entirety of which is incorporated by reference herein) is used as the base starting checkpoint for the model and fine-tuned on the generated training data.

As shown, computing device 100 receives input data 160. This input data 160 can include a dataset with one or more unannotated source documents which, in some examples, can be modified or annotated (e.g., by training data generation module 130 or a data annotation module 140) to create a training set (e.g., for factual consistency module 150). The input data 160 may also include one or more source text documents and abstractive text summaries of the same, for which factual consistency module 150 can develop, derive, or generate results relating to the verification of the factual consistency as between the source text document and a corresponding text summary. The generated training data and/or results can be provided as output 170 from computing device 100.

### Document-Sentence Approach for Factual Consistency Checking or Verification

Previously developed text summarization models typically check factual consistency on a sentence-sentence level, where each sentence of the summary is verified against each sentence from the source document. This is insufficient. For example, in some cases, it may be necessary to consider a longer, multi-sentence context from the source document due to ambiguities present in either of the compared sentences. As another example, summary sentences generated by typical text summarization models might paraphrase multiple fragments of the source document, while source document sentences might use certain linguistic constructs, such as coreference, which bind different parts of the document together. In addition, errors made by typical summarization models can relate to the use of incorrect entity names, numbers, and pronouns. Other errors such as negations and common-sense errors may also occur, albeit less often.

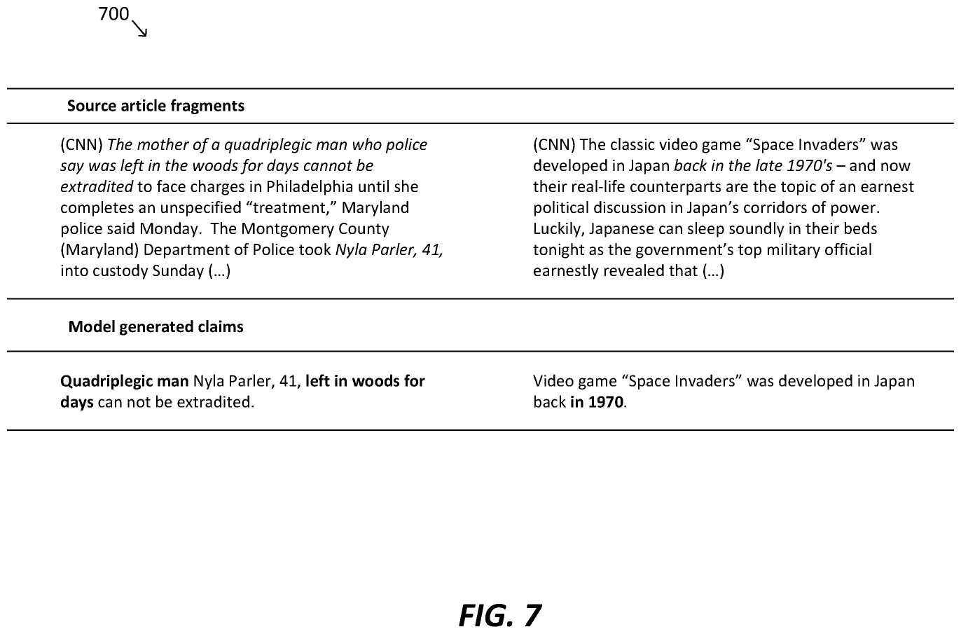

FIG. 7 shows a table 700 with examples of factually incorrect claims that may be output by summarization models. In table 700, fragments from various source articles or documents are provided at the top, while the respective claims or sentences generated by the model to summarize same are provided at the bottom. Italicized text highlights the support in the source documents for the generated claims, and bold text highlights the errors in the claims made by summarization models.

An analysis of such outputs from previously developed text summarization models provides valuable insight about the specifics of factual errors made during the generation of summaries and possible means of detecting such errors. Taking these insights into account, according to some embodiments, the present disclosure provides a document-sentence approach for factual consistency checking, where each sentence of the generated summary is verified against the entire body of the source document.

### Generating Training Data

Currently, there are no supervised training datasets for factual consistency checking. Creating a largescale, high-quality dataset with strong supervision collected from human annotators, however, can be prohibitively expensive and time consuming. Thus, according to some embodiments, systems and methods are provided for acquiring or generating training data for factual consistency checking by a neural network model.

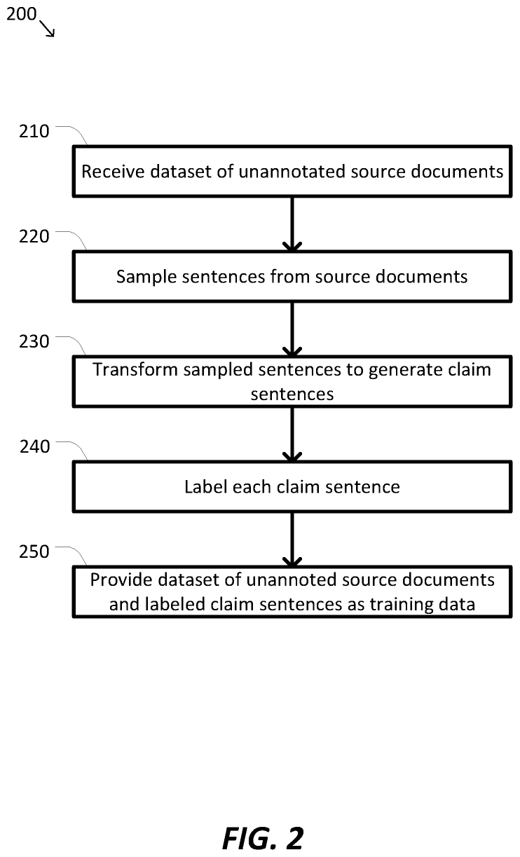

FIG. 2 is a simplified diagram of a function, process, or method 200 for generating an artificial, weakly-supervised data set for training a factual consistency checking model, according to some embodiments. One or more of the processes 210-250 of method 200 may be implemented, at least in part, in the form of executable code stored on non-transitory, tangible, machine-readable media that when run by one or more processors may cause the one or more processors to perform one or more of the processes 210-250. In some embodiments, method 200 may be performed or correspond to the operation of training data generation module 130 and its components sample module 132, transform module 134, and label module 136. (FIG. 1).

At a process 210, training data generation module 130 receives an unannotated collection or set S of source documents. In some examples, this data may comprise news articles from the CNN/DailyMail dataset as source documents. Each source document (e.g., article) comprises a number of sentences. In some embodiments, the data set includes source documents in the same domain as the summarization models that are to be checked or verified.

At a process 220, sample module 132 of training data generation module 130 extracts text samples from the source documents. In some embodiments, each sample is a single sentence.

At a process 230, transform module 134 of data generation module 130 performs one or more text transformations T on the text or single sentences sampled from source documents S in order to create a training dataset—i.e., generated data points D. More specifically, the transformations generate novel claim sentences that may be used as examples for training a factual consistency checking model. For each sampled sentence, the transformation converts the sentence to a respective novel claim sentence. In some embodiments, these transformations may include paraphrase transformation, entity and number swapping transformation, pronoun swapping data augmentation, sentence negation transformation, and injection of noise.

Paraphrasing: In a paraphrasing transformation, one or more sentences from a source document are rephrased, e.g., by data generation module 130. In some embodiments, paraphrases are produced by backtranslation using Neural Machine Translation (NMT) systems, as described in more detail in Edunov et al., “Understanding back-translation at scale,” CoRR, abs/1808.09381, 2018, which is incorporated by reference herein. With this technique, an original sentence in English language is translated to an intermediate, non-English language, and the translated back to English yielding a semantically-equivalent sentence with minor syntactic and lexical changes. French, German, Chinese, Spanish, and Russian can be used as intermediate languages. These languages were chosen based on the performance of recent NMT systems with the expectation that well-performing languages could ensure better translation quality. In some examples, Google Cloud Translation API 2 could be used for translation.

Entity and number swapping: To learn how to identify examples where the summarization model uses incorrect numbers and entities in generated text, data generation module 130 uses or applies entity and number swapping transformation to one or more sentences in the dataset. In some embodiments, module 130 may use or apply a named-entity recognition (NER) system to both the claim sentence and source document to extract all mentioned entities. In some examples, to generate a novel, semantically changed claim, an entity in the claim sentence is replaced with an entity from the source document. Both of the swapped entities are chosen at random while ensuring that they are unique. In some embodiments, extracted entities are divided into two groups: (1) named entities, which cover or include person, location and institution names, and (2) number entities, which cover or include dates and all other numeric values. In some examples, entities are swapped within their groups—e.g., named entities would only be replaced with other named entities. In some embodiments, the SpaCyNER tagger (as described in more detail in Honnibal et al., “spaCy 2: Natural language understanding with Bloom embeddings, convolutional neural networks and incremental parsing,” http://spacy.io, 2017, which is incorporated by reference herein) is used or applied.

Pronoun swapping: To teach the factual consistency checking model how to find incorrect pronoun use in claim sentences, data generation module 130 uses or applies a pronoun swapping data augmentation to some of the sampled sentences of the dataset. In some embodiments, all gender-specific pronouns (e.g., “he,” “she,” “him,” “her,” “his”) are first extracted from the claim sentence. Next, transform module 134 swaps a randomly chosen pronoun with a different one from the same pronoun group to ensure syntactic correctness—e.g., a possessive pronoun (“his”) could be replaced with another possessive pronoun (“her”). New sentences are considered semantically variant.

Sentence negation: To teach the factual consistency checking model how to handle negated sentences, data generation module 130 uses or applies sentence negation transformation. In some embodiments, in a first step, a claim sentence is scanned in search of auxiliary verbs. To switch the meaning of the new or transformed sentence, in a second step, a randomly chosen auxiliary verb is replaced with its negation. Positive sentences would be negated by adding “not” or “n't” after the chosen verb, whereas negative sentences would be switched by removing such negation.

Noise injection: Because a verified text summary is generated by a deep neural network, it is expected that the text summary will contain certain types of noise. In order to make the trained factual consistency model robust to such generation errors, in some embodiments, one or more training examples are injected with noise using a simple algorithm. In some examples, for each token (e.g., word or grouping of characters) in a claim sentence, transform module 134 decides whether or not to add or inject noise at the given position with a preset probability. If noise should be injected, the token is randomly duplicated or removed from the sequence.

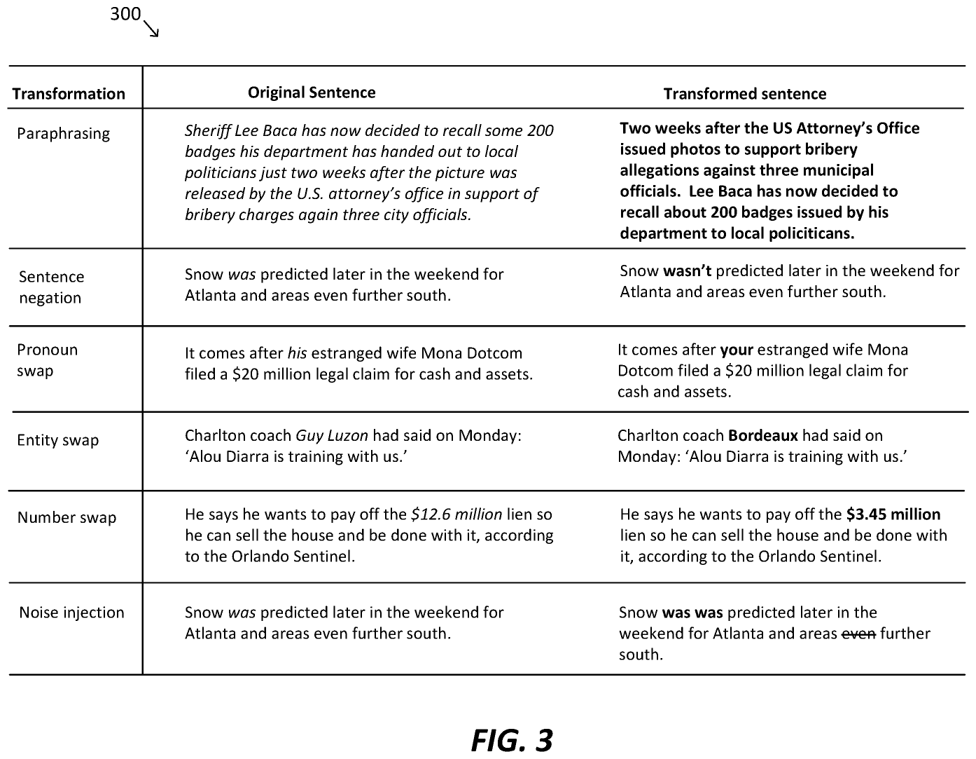

Examples of the various text transformations—e.g., paraphrase transformation, entity and number swapping transformation, pronoun swapping data augmentation, sentence negation transformation, and injection of noise—to generate training data are shown in the table 300 of FIG. 3. Table 300 shows examples of original sentences or claims and their transformed forms, for example, as generated by the transformation processes. Italicized and bold text highlight the changes made by the transformations.

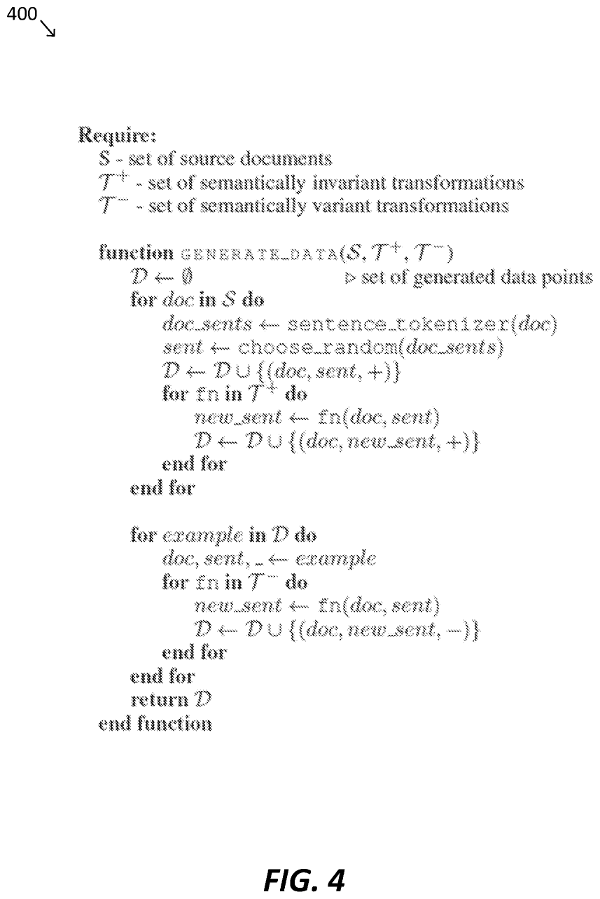

Examples of the text transformations of paraphrasing, sentence negation, pronoun swapping, entity swapping, number swapping, and noise injection are presented or illustrated in the table 400 shown in FIG. 4. Table 400 shows examples of original sentences or claims and their transformed forms, for example, as generated by the transformation processes.

At a process 240, label module 136 of training data generation module 130 labels each novel claim sentence. Each novel claim sentence generated by transformation can be either semantically variant or semantically invariant from the respective sampled sentence. For a semantically invariant transformation, the meaning of novel claim sentence is consistent with that of the original sentence. For a semantically variant transformation, the meaning of novel claim sentence is inconsistent with that of the original sentence. Referring FIG. 3, the paraphrasing transformation example is a semantically invariant transformation, whereas the transformation examples for sentence negation, pronoun swap, entity swap, and number swap are semantically variant transformations. Each novel claim sentence generated by a transformation is labeled according to whether or not it is semantically invariant or variant compared to the respective sampled original sentence. In some embodiments, a novel claim sentence is labeled as CONSISTENT or CORRECT if it is semantically invariant from the respective sampled sentence. And a novel claim sentence is labeled as INCONSISTENT or INCORRECT if it is semantically variant from the respective sampled sentence.

At a process 250, the set of unannotated source documents S and the labeled novel claim sentences are provided as a training data set to a neural network language model for factual consistency verification or checking. Using an artificially generated dataset allows for creation of large volumes of data at a marginal cost.

In some embodiments, the data generation process or method also allows or includes collecting additional metadata that can be used in the training process. In some examples, the metadata can contain information about the original location of the extracted claim in the source document and the locations in the claim where text transformations were applied.

FIG. 4 illustrates a procedure or algorithm 400 to generate weakly-supervised training data according to some embodiments. In some embodiments, the algorithm 400 is executed by training data generation module 130 when performing the method 200 of FIG. 2. Referring to FIG. 4, S is the set of unannotated source documents. T+ is the set of semantically invariant text transformations, T⁻ is the set of semantically variant text transformations. + is a positive label, corresponding to CONSISTENT or CORRECT. − is a negative label, corresponding to INCONSISTENT or INCORRECT. In some embodiments, 1,003,355 training examples were created, out of which 50.2% were labeled as negative (e.g., INCONSISTENT) and the remaining 49.8% were labeled as positive (e.g., CONSISTENT).

### Annotated Development and Test Data

Apart from the artificially generated training set, according to some embodiments, systems and methods of the present disclosure provide for the creation of separate, manually annotated, development and test sets. In some embodiments, the process or method for manual annotation can be accomplished using training data annotation module 140 (FIG. 1). In some embodiments, training data annotation module 140 provides or supports an interface by which human users can receive, retrieve, and view data or information (e.g., one or more datasets of textual documents), and provide input (e.g., annotations) to generate or develop an annotated dataset.

In some embodiments, the manually annotated dataset utilizes summaries output by state-of-the-art summarization models, including extractive, abstractive, and hybrid approaches (e.g., as described in more detail in Don et al., “Hedge trimmer: A parse-and-trim approach to headline generation,” in HLT-NAACL (2003); Paulus et al., “A deep reinforced model for abstractive summarization,” in ICLR (2017); and Gehrmann et al., “Bottom-up abstractive summarization, in EMNLP, pages 4098-4109, Association for Computational Linguistics (2018), all of which are incorporated by reference herein). Training data annotation module 140 splits each summary into separate sentences, and allows the (document, sentence) pairs to be annotated by human annotators. In some examples, this annotation can be made through crowd sourcing platforms. Because the focus is to collect data that would allow verification of the factual consistency of summarization models, in some embodiments, any unreadable sentences caused by poor generation are not labeled. In some examples, the development set comprises 931 examples, and the test set comprises 503 examples.

### Model for Factual Consistency Checking

According to some embodiments, the systems and methods for factual consistency checking disclosed herein (e.g., factual consistency module 150 of FIG. 1) can be implemented at least in part by one or more neural network models. In some embodiments, the neural network model can comprise or adopt a language representational model operable to perform one or more natural language understanding (NLU) tasks (including natural language inference).

In some embodiments, the neural network language model coming uses a pre-trained transformer-based models such as, for example, a Bidirectional Encoder Representations from Transformers (BERT) model as described in more detail in Devlin et al., “BERT: Pre-training of Deep Bidirectional Transformers for Language Understanding,” In Proceedings of the 2019 Conference of the North American Chapter of the Association for Computational Linguistics: Human Language Technologies, Volume 1 (Long and Short Papers), pages 4171-4186, which is incorporated by reference herein. In some examples, an uncased, base BERT architecture is used as the starting checkpoint for the models, and trained or fine-tuned on the generated training data (e.g., generated by training data generation module 130 performing text transformations such as paraphrasing, entity and number swapping, pronoun swapping, sentence negation, and noise injection; and/or annotated by human annotators through training data annotation module 140).

In some embodiments, the neural network models are implemented using the Huggingface Transformers library (as described in more detail in Wolf et al., “Transformers: State-of-the-art natural language processing,” arxiv.org/abs/1910.03771, 2019, which is incorporated by reference) written in PyTorch. In some embodiments, the models are trained on the artificially created data for 10 epochs using batch size of 12 examples and learning rate of 2e−5. After training, the model (e.g., implementing factual consistency module 150) can be applied or used to check for factual consistency of text summarizations generated by one or more summarization models for respective source documents.

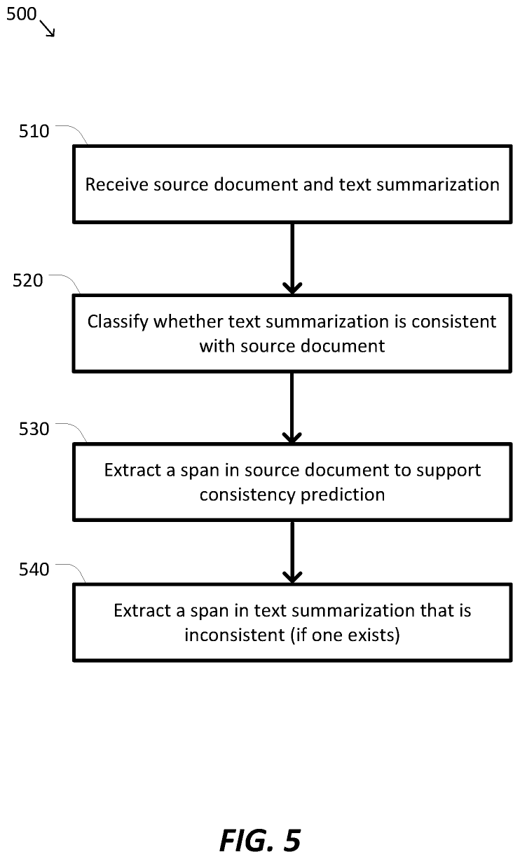

FIG. 5 is a simplified diagram of a method 500, according to some embodiments, for checking factual consistency. One or more of the processes 510-530 of method 500 may be implemented, at least in part, in the form of executable code stored on non-transitory, tangible, machine-readable media that when run by one or more processors may cause the one or more processors to perform one or more of the processes 510-530. In some embodiments, method 500 may correspond to the method used by factual consistency module 150 to check for the factual consistency of text summarizations.

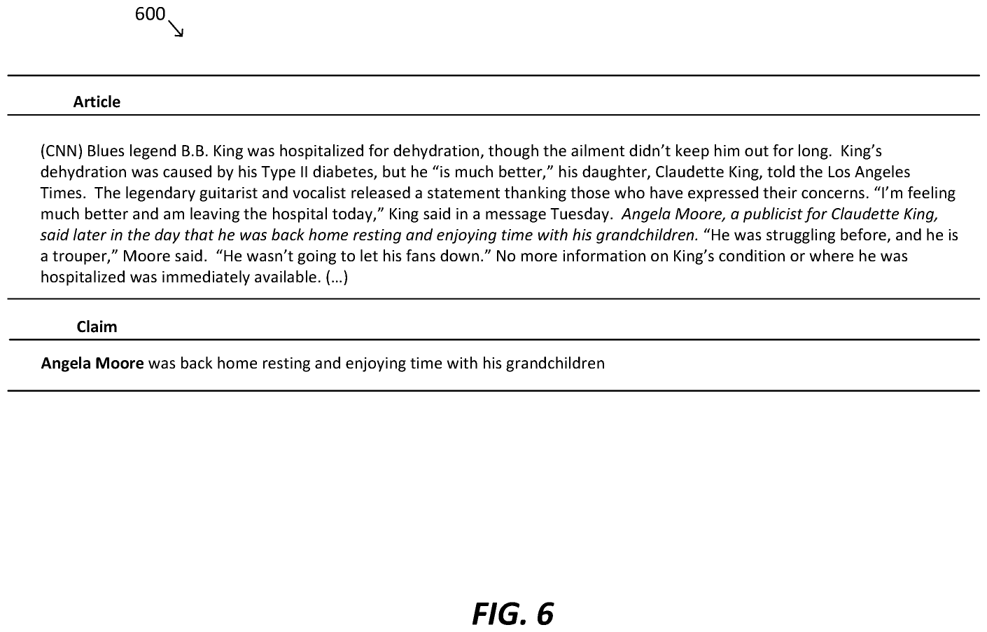

At a process 510, the factual consistency neural network model (e.g., factual consistency module 150) is provided with or receives (e.g., as input 160) one or more source documents and text summarizations for the same. The text summarization may be generated by a summarization model from a respective source document. In some embodiments, the text summarization is in the form of a claim sentence. An example of such source document (e.g., article) and claim sentence is illustrated in table 600 of FIG. 6.

At a process 520, factual consistency model determines or classifies whether the text summarization or claim sentence (i.e., “Angela Moore was back home resting and enjoying time with his grandchildren.”) remains factually consistent with the source document. In some embodiments, the model may perform two-way classification—e.g., using a single-layer classifier based on the [CLS] token—to classify the claim sentence as either “CONSISTENT” (or correct) or “INCONSISTENT” (or incorrect) with the source document. Referring to the example of FIG. 6, the factual consistency module 150 classifies the claim sentence as INCONSISTENT or incorrect. This embodiment of the model can be referred to as the factual consistency checking (FactCC) model.

In some embodiments, the factual consistency model may be configured to identify the portion or span (e.g., words, phrases, sentences) of the source document that should support the claim sentence. Thus, at a process 530, factual consistency module 150 extracts, highlights, or otherwise identifies a span in the source documents to support the consistency prediction. In some examples, to accomplish this, the factual consistency model may comprise or be trained with additional span selection heads using supervision of start and end indices for selection and transformation spans in the source document and claim sentence. This embodiment of the model or factual consistency module 150 may be referred to as the factual consistency checking model with explanations (FactCCX) model. With reference to the example shown in FIG. 6, italicized text indicates the span of the source document (i.e., “Angela Moore, a publicist for Claudette King, said later in the day that he was back home resting and enjoying time with his grandchildren.”) that should contain support for the claim sentence (i.e., “Angela Moore was back home resting and enjoying time with his grandchildren.”).

At a process 540, if the text summarization or claim sentence is inconsistent with the source document, factual consistency module 150 extracts, highlights, or otherwise identifies the portion or span in the claim sentence that is inconsistent or where a possible mistake was made. Referring to the example shown in FIG. 6, bold text in the claim sentence indicates the span of the claim sentence (i.e., “Angela Moore”) that is identified as INCONSISTENT or incorrect. In some embodiments, span identification and extraction can be accomplished by training the neural network to predict the start and end positions in a document of the span of text which is inconsistent with a span of text in the claim sentence. In some embodiments, the neural network can be trained to predict the start and end position in the claim sentence of the span of text which is inconsistent with a span of text in the document. In some embodiments, a single base neural network can be trained with or include one or more output modules. In some examples, the FactCC network or model only has a single output module, which predicts whether the claim sentence and document are consistent or inconsistent with each other. In some examples, the FactCCX model is trained with additional output modules: the first module extracts (by the aforementioned prediction of start and end tokens) the portion of the document that is inconsistent with a portion of the claim sentence, and the second module extracts by the same method the associated portion of the claim sentence.

The processes 510-530 of method 500 are not required to be performed in any particular order, and not every process is performed on each sentence of a source document.

Some examples of computing devices, such as computing device 100 may include non-transitory, tangible, machine readable media that include executable code that when run by one or more processors (e.g., processor 110) may cause the one or more processors to perform the processes of methods 200 and 500. Some common forms of machine readable media that may include the processes of methods 200 and 500 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

### Results

Results on the systems and methods employing or implementing the weakly-supervised model-based approach, trained or fine-tuned with the artificially generated training dataset, and applied or used for verifying or checking factual consistency and identifying conflicts between source documents and a generated summary are presented, and may be compared against other methods or approaches. In some examples, these other approaches include fact consistency checking models trained on the MNLI entailment data (as described in more detail in Williams et al., “A broad-coverage challenge corpus for sentence understanding through inference,” In Proceedings of the 2018 Conference of the North American Chapter of the Association for Computational Linguistics: Human Language Technologies, Volume 1 (Long Papers). Association for Computational Linguistics, 2018) and FEVER fact-checking data (as described in more detail in Thorne et al., “FEVER: a large-scale dataset for fact extraction and verification,” CoRR, abs/1803.05355, 2018).

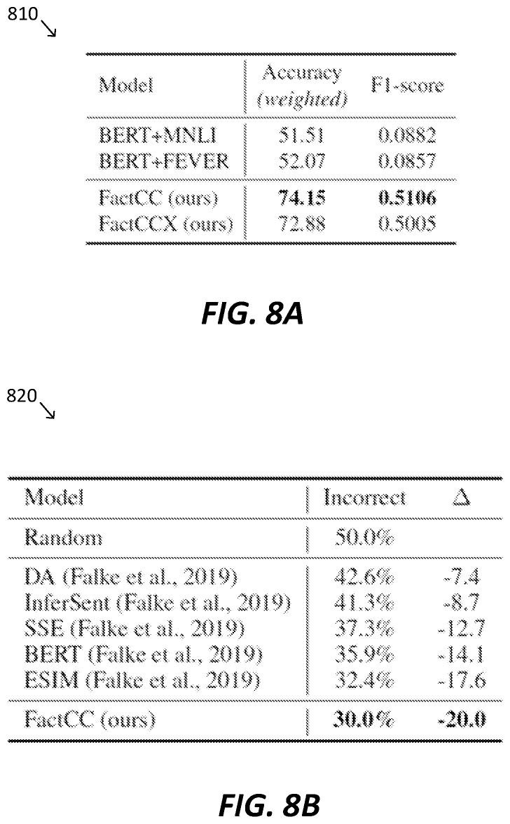

Results show that the factual consistency checking models according to embodiments of the present disclosure (e.g., FactCC and FactCCX) outperform other classifiers (such as trained on the MNLI and FEVER datasets), despite being trained using weakly-supervised data of the artificially generated dataset. This is illustrated, for example, in table 810 of FIG. 8A, which shows performance of various factual consistency checking models evaluated by means of weighted (class-balanced) accuracy and F1 score on the manually annotated test set. It is further illustrated in the table 820 of FIG. 8B, which shows results for a sentence ranking experiment where an article sentence is paired with two claim sentences, positive and negative, and the goal is to see how often a model assigns a higher probability of being correct to the positive rather than the negative claim.

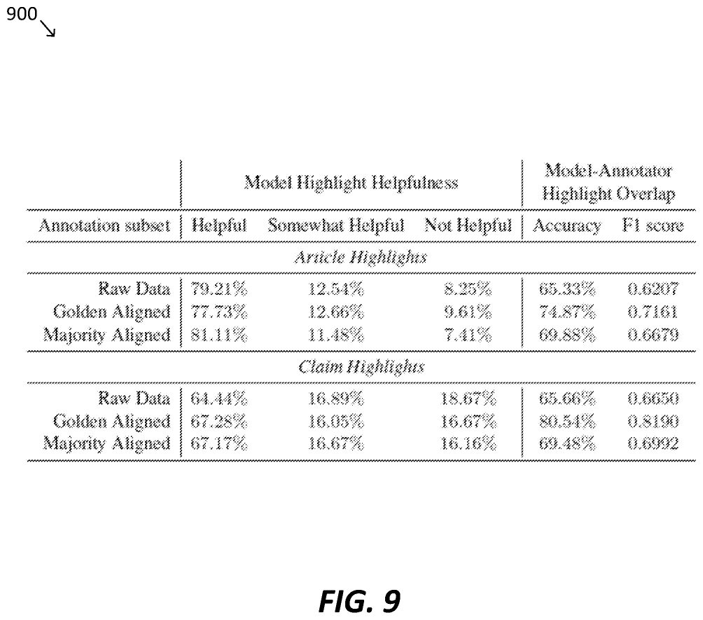

Furthermore, to establish whether the spans in the article and claim generated by the models of the present disclosure are helpful for the task of fact checking, such spans were also evaluated, for example, by human annotators. In some embodiments, each of the presented document-sentence was augmented with the highlighted spans output by FactCCX. Judges were asked to evaluate the correctness of the claim and instructed to use the provided segment highlights only as suggestions. After the annotation task, judges where asked whether they found the highlighted spans helpful for solving the task. Helpfulness of article and claim highlights was evaluated separately. The overlap between spans was evaluated using two metrics—accuracy based on a binary score whether the entire model-generated span was contained within the human selected span and F1 score between the tokens of the two spans, with human selected spans were considered ground-truth. The results are shown in table 900 of FIG. 9.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and in a manner consistent with the scope of the embodiments disclosed herein.

What is claimed is:

1. A computer-implemented method for verifying factual consistency as between a source text document and a corresponding text summary, the method comprising:
providing a factual consistency checking model trained with a training data set, wherein the training data set is generated by:
receiving a dataset with one or more unannotated source documents, each source document comprising a plurality of sentences;
sampling one or more sentences from the one or more unannotated source documents;
for each sampled sentence:
performing a transformation to generate a respective novel claim sentence; and
labeling the respective novel claim sentence according to whether it is semantically variant or semantically invariant from the sampled sentence;
receiving the source text document and the corresponding text summary as input to the trained factual consistency checking model, wherein the corresponding text summary is generated by a text summarization model;
classifying by the trained factual consistency checking model whether the corresponding text summary is factually consistent with the source text document; and
if the corresponding text summary is classified as factually consistent with the source text document, identifying by the trained factual consistency checking model a span in the source text document that supports the corresponding text summary.

2. The method of claim 1, comprising labeling the respective novel claim sentence as correct if the respective novel claim sentence is semantically invariant from the sampled sentence.

3. The method of claim 1, comprising labeling the respective novel claim sentence as incorrect if the respective novel claim sentence is semantically variant from the sampled sentence.

4. The method of claim 1, wherein the transformation comprises one of a paraphrase transformation, an entity and number swapping transformation, a pronoun swapping data augmentation, a sentence negation transformation, and injection of noise.

5. The method of claim 4, comprising labeling the respective novel claim sentence as incorrect if one of an entity and number swapping transformation, a pronoun swapping data augmentation, and a sentence negation transformation is performed on the sampled sentence.

6. The method of claim 1, comprising extracting the span in the source document that supports the corresponding text summary.

7. The method of claim 1, wherein if the corresponding text summary is classified as factually inconsistent with the source text document, comprising identifying by the factual consistency checking model a span in the source text document that is inconsistent with the corresponding text summary.

8. A non-transitory machine-readable medium comprising executable code which when executed by one or more processors associated with a computer are adapted to cause the one or more processors to perform a method for verifying factual consistency as between a source text document and a corresponding text summary comprising:
providing a factual consistency checking model trained with a training data set, wherein the training data set is generated by:
receiving a dataset with one or more unannotated source documents, each source document comprising a plurality of sentences;
sampling one or more sentences from the one or more unannotated source documents;
for each sampled sentence:
performing a transformation to generate a respective novel claim sentence; and
labeling the respective novel claim sentence according to whether it is semantically variant or semantically invariant from the sampled sentence;
receiving the source text document and the corresponding text summary as input to the trained factual consistency checking model, wherein the corresponding text summary is generated by a text summarization model;
classifying by the trained factual consistency checking model whether the corresponding text summary is factually consistent with the source text document; and
if the corresponding text summary is classified as factually consistent with the source text document, identifying by the trained factual consistency checking model a span in the source text document that supports the corresponding text summary.

9. The non-transitory machine-readable medium of claim 8, wherein the method comprises labeling the respective novel claim sentence as correct if the respective novel claim sentence is semantically invariant from the sampled sentence.

10. The non-transitory machine-readable medium of claim 8, wherein the method comprises labeling the respective novel claim sentence as incorrect if the respective novel claim sentence is semantically variant from the sampled sentence.

11. The non-transitory machine-readable medium of claim 8, wherein the transformation comprises one of a paraphrase transformation, an entity and number swapping transformation, a pronoun swapping data augmentation, a sentence negation transformation, and injection of noise.

12. The non-transitory machine-readable medium of claim 11, wherein the method comprises labeling the respective novel claim sentence as incorrect if one of an entity and number swapping transformation, a pronoun swapping data augmentation, and a sentence negation transformation is performed on the sampled sentence.

13. The non-transitory machine-readable medium of claim 8, wherein the method comprises extracting the span in the source document that supports the corresponding text summary.

14. The non-transitory machine-readable medium of claim 8, wherein if the corresponding text summary is classified as factually inconsistent with the source text document, the method comprises identifying by the factual consistency checking model a span in the source text document that is inconsistent with the corresponding text summary.

15. A system for verifying factual consistency as between a source text document and a corresponding text summary, the system comprising:
a training data generation module operable to generate a training data set by:
receiving a dataset with one or more unannotated source documents, each source document comprising a plurality of sentences;
sampling one or more sentences from the one or more unannotated source documents;
for each sampled sentence:
performing a transformation to generate a respective novel claim sentence; and
labeling the respective novel claim sentence according to whether it is semantically variant or semantically invariant from the sampled sentence; and
a factual consistency checking model trained on the training data set generated by the training data generation module, the factual consistency model operable to:
receive the source text document and the corresponding text summary as input, wherein the corresponding text summary is generated by a text summarization model;
classify whether the corresponding text summary is factually consistent with the source text document; and
if the corresponding text summary is classified as factually consistent with the source text document, identify a span in the source text document that supports the corresponding text summary.

16. The system of claim 15, wherein the factual consistency checking model comprises a neural network language model.

17. The system of claim 15, wherein the training data generation module is operable to label the respective novel claim sentence as correct if it is semantically invariant from the sampled sentence.

18. The system of claim 15, wherein the training data generation module is operable to label the respective novel claim sentence as incorrect if it is semantically variant from the sampled sentence.

19. The system of claim 15, wherein the transformation comprises one of a paraphrase transformation, an entity and number swapping transformation, a pronoun swapping data augmentation, a sentence negation transformation, and injection of noise.

20. The system of claim 20, wherein the training data generation module is operable to label the respective novel claim sentence as incorrect if one of an entity and number swapping transformation, a pronoun swapping data augmentation, and a sentence negation transformation is performed on the sampled sentence.

21. The system of claim 15, wherein the factual consistency checking model is operable to extract the span in the source document that supports the corresponding text summary.

22. The system of claim 15, wherein if the corresponding text summary is classified as factually inconsistent with the source text document, the factual consistency checking model is operable to identify a span in the source text document that is inconsistent with the corresponding text summary.
